(19) United States
(12) Patent Application Publication
(10) Pub. No.: US 2015/0222756 A1
(43) Pub. Date: Aug. 6, 2015

(54) PAGER ADD-ON DEVICE FOR A MOBILE DEVICE

(71) Applicant: WISEC LTD., Beer Sheva (IL)

(72) Inventors: Amir Tsaliah, Haifa (IL); Ran Krauss, Beer Sheva (IL)

(21) Appl. No.: 14/424,397

(22) PCT Filed: Aug. 26, 2013
(86) PCT No.: PCT/IL2013/050722

§ 371 Date: Feb. 26, 2015

(30) Foreign Application Priority Data
Aug. 27, 2012 (IL) 221666

(51) Int. Cl. H04M 11/02; H04L 12/24; H04W 64/00; H04W 76/02; H04W 72/00; H04W 76/00; H04W 4/22

(52) U.S. Cl. CPC H04M 11/022; H04W 76/007; H04L 41/0206; H04W 4/22; H04W 76/02; H04W 72/005; H04W 64/00

(57) ABSTRACT

The present invention is an add-on device for mobile devices and a messaging method. The present invention harnesses the broadcast rapid ability of a pager and combines it with the advanced processing location and graphic abilities of a mobile device. The add-on device of the invention connects to the mobile device in order to transfer messages to a vast number of users, rapidly in real time, reliably and without dependence on the cellular network.

### FIELD OF INVENTION

The invention is in the field of messaging systems, mobile devices, tablets and pagers.

### BACKGROUND OF THE INVENTION

In the modern world and as the technology advances, mobile devices are becoming an integral part of life. Mobile devices are used for many applications and functions, and most people carry their mobile device wherever they are. However, in times of emergency, as in natural disaster or missile threat when a massage has to be delivered to a mass of people, and the ability to warn the population rapidly is critical, the cellular network is overloaded and can not guarantee the transfer of the massage or a rapid transfer. Sometimes in cases of emergency, the cellular system crashes for at least a few minutes or even for hours, and then no data traffic can be obtained through the cellular system. Therefore, security forces, life-saving forces, journalists and other groups which have to be alerted under their role uses pagers to transfer emergency massages. Pagers are used to send messages rapidly to a vast amount of users. However, today the pager device is simple and un-advanced and average people do not carry a pager with them since it is a cumbersome device.

It is therefore an object of the present invention to provide a device which is able to harness the broadcast rapid ability of the pager and combine it with the advanced processing, location and graphic abilities of a mobile device.

It is therefore another object of the present invention to provide an add-on device for mobile device, which connects to the mobile device in order to transfer messages to a vast amount of users, rapidly in real time without dependence on the cellular network and to deliver those messages depending on the location of the user.

It is yet another object of the present invention to provide an add-on device for mobile device, which connects to the mobile device in order to transfer emergency messages which are highly important and must be transferred urgently and reliably in real time to a very large number of subscribers.

Further purposes and advantages of this invention will appear as the description proceeds.

### SUMMARY OF THE INVENTION

The invention is an add-on device for a mobile device adapted to communicate with said mobile device, comprising:

a pager unit for receiving messages from a transmission station with no dependence in a cellular network, wherein said pager unit includes at least one communication channel; and a communication module coupled to said pager unit, for transferring data corresponding to said received message, from said pager unit to said mobile device, either by wired or wireless communication link, wherein said mobile device is adapted to process said received message and generate an indication regarding said received message.

In an embodiment of the invention, the pager unit further comprises a processing module for decoding the received message and accordingly generating an indication regarding said received message.

In an embodiment of the invention, the pager unit comprises at least two communication channels, one for receiving emergency messages and the other(s) for receiving non-emergency messages; wherein every communication channel is adapted to operate in a different frequency.

In an embodiment of the invention, the indication is generated by a software application adapted to be executed on the mobile device.

In an embodiment of the invention, the wireless communication link is performed via Bluetooth, Zigbee or WiFi.

In an embodiment of the invention, the wired communication link is performed via an I/O data port of the mobile device.

In an embodiment of the invention, the wired communication link is performed via an earphone jack of the mobile device.

In an embodiment of the invention, the indication is selectively generated according to the physical location of the mobile device.

In an embodiment of the invention, the add-on device further comprises a power source unit for powering said device.

In an embodiment of the invention, the power source unit includes a charger and a battery.

In an embodiment of the invention, the power source unit includes a solar panel.

In an embodiment of the invention, the add-on device further comprises alerting means for indicating of received messages.

In an embodiment of the invention, the alerting means are selected from the group consisting of an audible element, a tactile element, a visual element or any combination thereof.

In an embodiment of the invention, the add-on device is integrated with a casing formed to accommodate the mobile device.

In another aspect the invention is a messaging method for delivering messages from an add-on device to a mobile device, comprising the steps of:
receiving one way broadcast messages from a transmission station, with no dependence in a cellular network, by a pager unit of said add-on device;
transferring said received message to the mobile device either wirelessly or by a wired communication link; and
processing said received message and selectively generating an indication regarding the received message by a software application executed by said mobile device according to one or more predefined rules.

In an embodiment of the invention, the predefined rules are selected from the group consisting of: physical location of the mobile device, the sender, time, message priority or any combination thereof.

In an embodiment of the invention, the indication is generated in form of: an audible indication, a tactile indication, a visual indication or any combination thereof.

All the above and other characteristics and advantages of the invention will be further understood through the following illustrative and non-limitative description of embodiments thereof, with reference to the appended drawings. In the drawings the same numerals are sometimes used to indicate the same elements in different drawings.

### BRIEF DESCRIPTION OF THE DRAWINGS

FIG. 1 schematically shows a general structure of the present invention according to one embodiment of the invention;

FIGS. 2-6 schematically show several configurations of the system of the present invention according to one embodiment of the invention;

FIGS. 7-8 schematically show the system of the present invention according to a second embodiment of the invention;

FIG. 9 schematically shows the system of the present invention according to a third embodiment of the invention.

### DETAILED DESCRIPTION OF THE EMBODIMENTS OF THE INVENTION

Throughout the description, the term “pager” refers to a communication unit for at least receiving one way broadcast message(s) via at least one RF receiver.

While certain examples may refer to a smart phone, other mobile devices can be used as well, such as, without limitation, a tablet, a cellular phone, a personal digital assistant (PDA), and so on.

The present invention is an add-on device for mobile devices and a messaging method. The present invention harnesses the broadcast rapid ability of a pager and combines it with the advanced processing location and graphic abilities of a mobile device. The add-on device of the invention connects to the mobile device in order to transfer messages to a vast number of users, rapidly in real time, reliably and without dependence on the cellular network.

According to one embodiment, the present invention comprises a compact pager unit adapted to be configured to a mobile device case in order to transfer messages to the mobile device, in any time the sender does not want to be dependent on the cellular network, especially, in times of emergency.

The invention is a universal system which can be adapted to any mobile device and which provides an add-on device that can receive emergency messages which were sent to a vast number of users in real time.

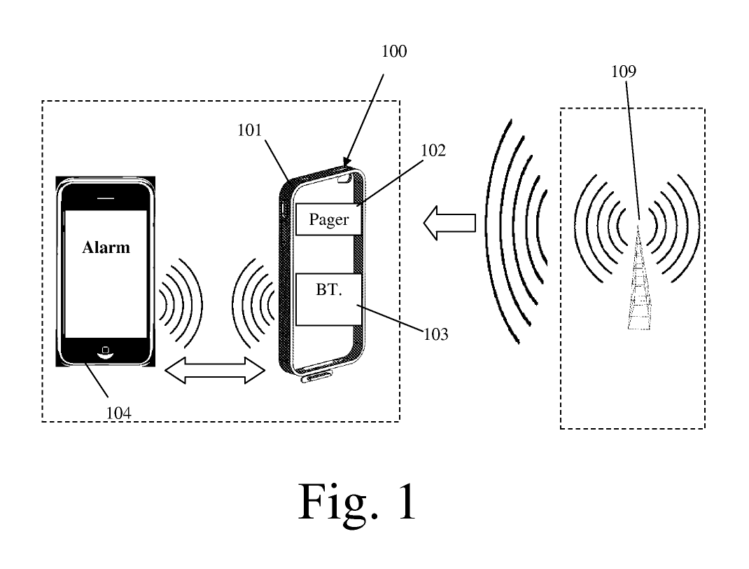

FIG. 1 shows an add-on device that can be used in conjunction with the invention. The add-on device illustrated in this figure is particularly convenient because it can be applied as an ad-on device to existing mobile devices without the need to carry out any alterations in the structure of the mobile device. The add-on device generally indicated by numeral 100 in the figure comprises a pager unit 102 and a local communication module 103 (e.g., a Bluetooth transceiver). The pager unit 102 (includes at least one RF receiver) and is electronically coupled with the local communication module 103. In this embodiment, the pager unit 102 and the local communication link 103 are integrated in a case 101 that is adapted to be attached to a mobile device 104. For example, the case 101 can be a protecting case made of a flexible polymeric material or any other material used for protecting cases.

The add-on device 100 and the corresponding mobile device 104 operate as follow:—When a massage is transmitted from a sender 109, the RF receiver of pager unit 102 receives a transmission from the parent regional;
The local communication module 103 (e.g., a Bluetooth transceiver) connects wirelessly with the mobile device 104 (e.g., via the Bluetooth connection of the mobile device) and delivers the received message to the mobile device 104;
A dedicated application which runs in the mobile device 104 receives the message, and the received message pops up in the mobile device screen through said application. The dedicated application may give priority to the add-on device message(s) over all other applications that are running at the same time. The message received in the pager unit 102 can be decoded in the pager unit 102 itself (e.g., by using a dedicated decoder module) or it can be decoded in the mobile device 104 by the dedicated application.

According to an embodiment of the invention, the add-on device 100 comprises a power source which supplies energy to elements of the add-on-device, such as the pager unit 102 and the local communication module 103. For example, the power source is a rechargeable battery. In this embodiment, in case the mobile device battery is uncharged (or the mobile device 104 is turned off) and the mobile device 104 can not receive messages, then the add-on device 100 continues to receive emergency messages and can accordingly generate an alert (e.g., an alarm sound via a built-in buzzer, a vibrate via a tactile element, etc.) in order to alert the user about an incoming message, while the mobile device is off.

According to an embodiment of the invention, the power source can be used as a backup battery for the mobile device.

According to an embodiment of the invention the pager unit 102 comprises at least one communication channel(s) for receiving messages. Each communication channel is secured and has a corresponding receiver. For example: the pager unit may comprise two communication channels (e.g., two receivers), one for receiving emergency message (e.g., at 400 MHz band) and the other for receiving regular (i.e., non-emergency) messages (e.g., at 900 MHz band). Another example can be a pager unit which comprises three communication channels, the first for emergency messages, the second for promotional/commercial messages and the third for non-emergency and non-promotional messages.

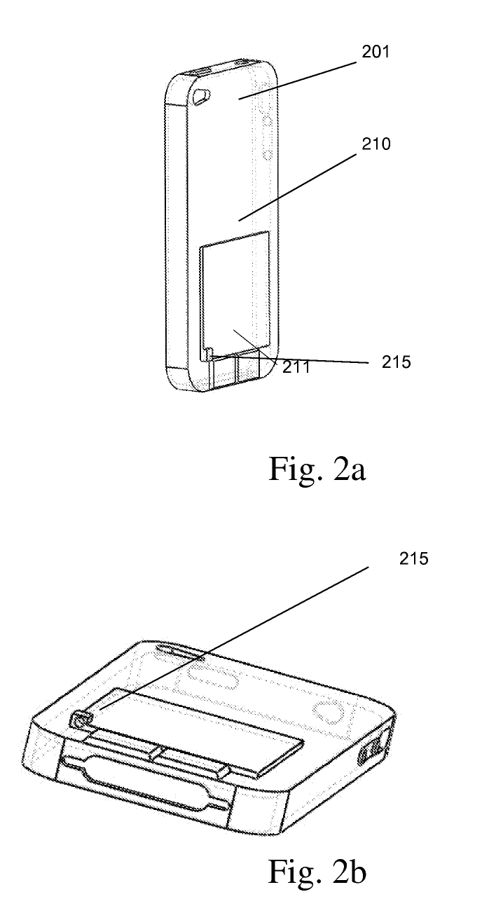

FIG. 2A shows a possible configuration of the mobile device case. The case 201 is made of a flexible polymeric material and a battery 210 is attached to said case 201. The battery 210 is connected to the pager unit 211, which comprises an RF receiver, Bluetooth transceiver a microphone and electronic circuit(s) (not shown). FIG. 2b shows a cable charger connection point 215, in order to charge the battery. Although FIG. 2b shows a cable charger connection point in the case 201, there are several options for charging the battery. A first option as shown in FIG. 2b is by using a common charger with a cable which charges the battery of the pager unit.

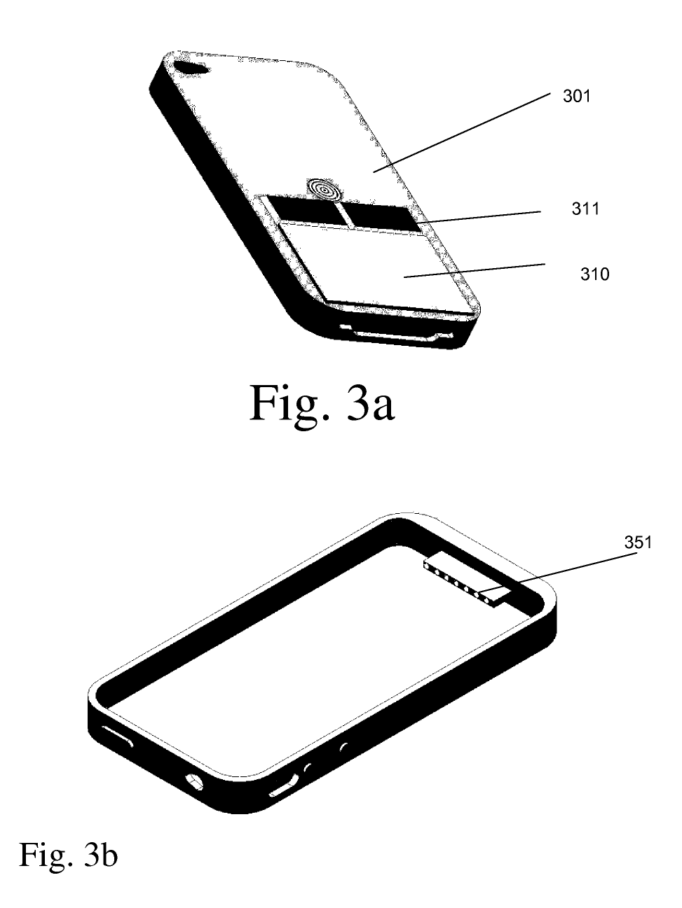

The charger cable can also be configured to charge the battery of the pager unit and the mobile device simultaneously, by using a serial connection (wired or wireless) to the charger, so that the charger charges the battery in the case of the mobile device and the battery in the case charges the battery of the mobile device. FIGS. 3a and 3b show a case 301 with a battery 310 which charges the pager unit 311 integrated in the case and simultaneously charges the battery of the mobile device through the communication link 351.

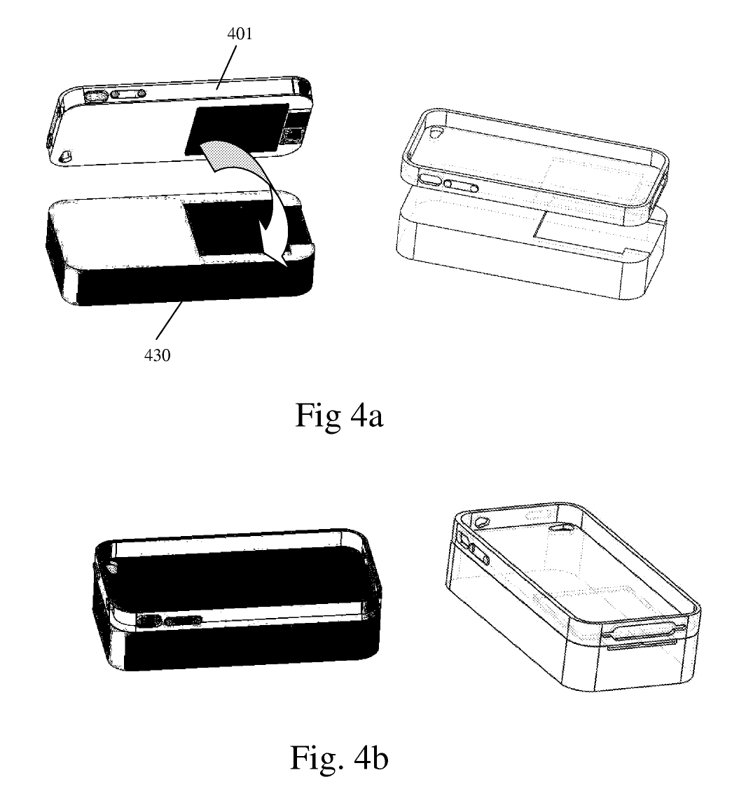

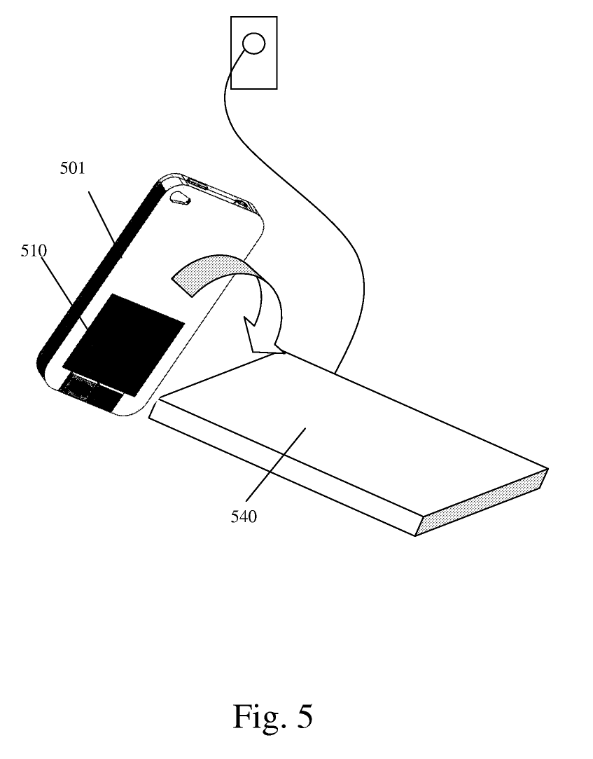

FIGS. 4a and 4b shows a third option for charging the system, by using a docking station 430, wherein, the user puts the case 401 of the mobile device with or without the mobile device on the docking station 430 which charges the system. FIG. 5 shows another option by using a special battery 510 which is integrated in the case 501 and which can be charged wirelessly on a dedicated charging surface 540.

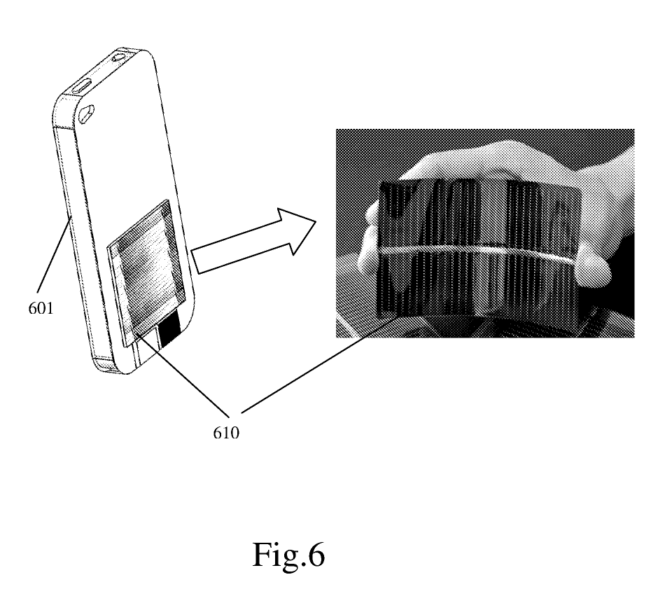

Another option is to use a solar charging element 610 which is integrated inside the case 601 of the mobile device as can be seen in FIG. 6.

Another option is to use a docking station to charge the system battery and the mobile device battery both as a combination of FIG. 3 and FIG. 4.

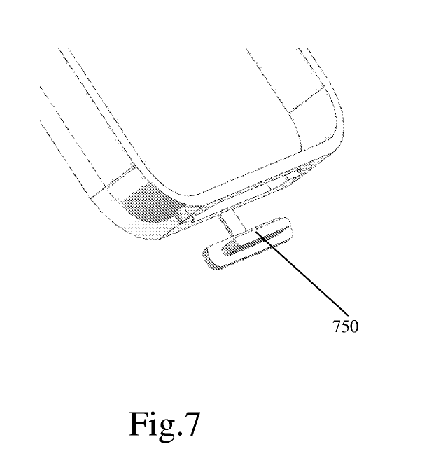

In an embodiment of the invention the connection between the pager unit and the mobile device, for the data transfer and for the charging of the pager unit is a wired communication link. FIG. 7 schematically shows a wired communication link that is implemented by a micro USB or USB configuration 750. The pager unit is powered by the mobile device battery through the wired connection, and a second battery is integrated in the case in order to be used when the battery of the mobile device is empty. If the battery of the mobile device is empty, the second battery in the case supplies the power needs for the continuation of the operation of the pager unit.

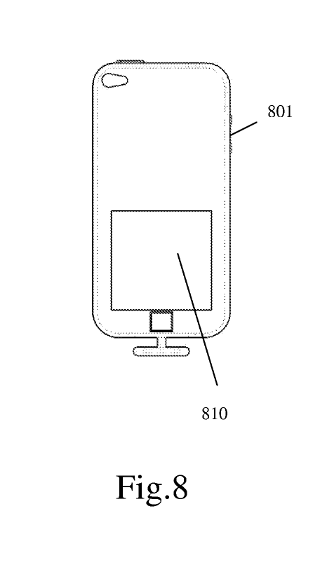

In another embodiment of the invention a solar panel is integrated in the case of the mobile device. The pager unit is powered by the battery of the mobile device and simultaneously the solar panel charges the battery of the mobile device. FIG. 8 shows the solar panel 810 integrated in the case 801 with the wired connection configuration.

In another embodiment of the invention a battery and solar panel are integrated in the case of the mobile device. The pager unit is powered by the battery in the case simultaneously the solar panel charges the battery of the pager.

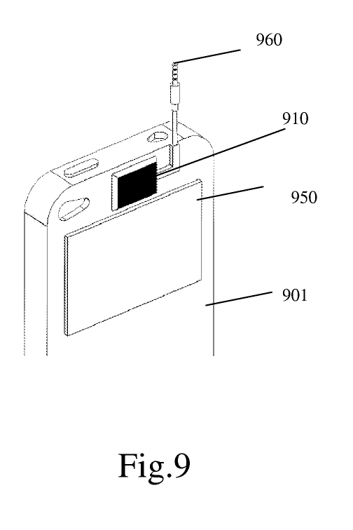

In another embodiment of the invention the communication link to the mobile device is through the earphones control jack connection. The earphone control allows the user to control the volume, to stop a song, to move songs backwards or forwards etc. According to this embodiment of the invention there is no transmission of the real data, but there is a database of all possible messages that can be received in the mobile device and a special sequence of signals that corresponds to every message. When a data is received in the pager the special sequence that corresponds to that message is transmitted to the mobile device through the earphone control connection and the message in the database of the mobile device that corresponds to the received sequence is retrieved and an indication is generated in the mobile device, for example: the message is displayed on the screen of the mobile device. FIG. 9 shows the case 901 of the mobile device with the earphone connection 960, the pager unit 910 and the battery 950.

In another embodiment of the invention the add-on device is attached to the back of the mobile device (for example by gluing). Another embodiment of the invention is to integrate the add-on device with a battery cover and replaces the original battery cover of the mobile device. The communication between the add-on device and the mobile device can be either by wired or wireless communication link, for example: by Bluetooth, by USB or by the earphones connection of the mobile device as explained above.

In another embodiment of the invention, the massages are selectively displayed according to the user predetermined priority.

The application in the mobile device which receives the messages from the add-on device always runs unless the mobile device is off. Once a message is received in the pager unit, it is processed and transferred to the mobile device. The processing of the message can be performed in the pager unit by a processing module or in the mobile device by the dedicated application. The message received may contain the following information: location, time, sender, level of Importance (emergency/regular) and the like.

In general, emergency messages gets priority over all the other applications that are running at the same time the message is received in the mobile device. The application of the system generates immediately an indication(s) regarding the received message. The indication(s) can be an audible indication, a tactile indication, a visual indication or any combination thereof. For example, when an emergency message is received the application displays the emergency message as a flashing and colorful message, accompanied by a sound and a vibration alarm from the mobile device. Another example for indicating a received message is by generating three sounds of beep and a vibration of the device. However, the user can choose to set the application to display only emergency messages that correspond to the physical location of the mobile device. When the selective mode is activated, the location of the mobile device is identified by a GPS or by antennas tracking or other tracking methods known in the art. After the location of the mobile device is tracked, the system scans the incoming messages and checks the correlation between the location of the mobile device and the location received in the message. If there is a correlation the system generates indication(s) regarding the received message. For example: In case of a missile threat on a city, when the mobile device is not around said city, the message is filtered and the mobile device will not generate an indication regarding the message.

In case the message is a non-emergency message the user can set the system to indicate messages according to different predetermined rules, such as: physical location of the mobile device, the sender, time, and message priority. For example, to display or not display messages from a specific sender, or according to a time restrictions. For non-emergency messages the user can also define and control the sound indication (enable/disable, volume, etc.), the tactile indication, the location selectivity, etc. the user can also define his preferences according to the configuration of the message, for instance: display the message as a popup message or not.

Although embodiments of the invention have been described by way of illustration, it will be understood that the invention may be carried out with many variations, modifications, and adaptations, without exceeding the scope of the claims.

1. A communication apparatus comprising:
a) a mobile communication device;
b) an add-on device for said mobile communication device, adapted to communicate, comprising:
a pager unit configured to receive a message from a transmission station with no dependence on a cellular network, wherein said pager unit includes at least one communication channel; and
a communication module coupled to said pager unit, configured to transfer data corresponding to said received message, from said pager unit to said mobile device, either by wired or wireless communication link, wherein said mobile communication device is adapted to process said received message and generate an indication regarding said received message;
c) location means at the mobile communication device, suitable to determine the location of the communication apparatus; and
d) software programmed to determine, based on the location of the communication apparatus, whether the indication regarding said received message should be generated, wherein said software is at said mobile communication device.

2. An add-on device for a communication apparatus that includes a mobile communication device, comprising:
a pager unit configured to receive a message from a transmission station with no dependence on a cellular network, wherein said pager unit includes at least one communication channel; and
a communication module coupled to said pager unit, configured to transfer data corresponding to said received message, from said pager unit to said mobile communication device, either by wired or wireless communication link, wherein said mobile communication device is adapted to process said received message and generate an indication regarding said received message.

3. An add-on device according to claim 2, in which the pager unit further comprises a processing module configured to decode the received message and generating generate the indication regarding said received message.

4. An add-on device according to claim 2, in which the pager unit comprises at least two communication channels, including a first channel for receiving emergency messages and at least one second channel for receiving non-emergency messages; wherein every communication channel is adapted to operate in a different frequency.

5. An add-on device according to claim 2, in which the indication is generated by a software application adapted to be executed on the mobile communication device.

6. An add-on device according to claim 2, wherein the communication module is configured to transfer data corresponding to said received message, from said pager unit to said mobile communication device, via a wireless communication link performed via Bluetooth, Zigbee or WiFi.

7. An add-on device according to claim 2, wherein the communication module is configured to transfer data corresponding to said received message, from said pager unit to said mobile communication device, via a wired communication link performed via an I/O data port of the mobile communication device.

8. An add-on device according to claim 2, wherein the communication module is configured to transfer data corresponding to said received message, from said pager unit to said mobile communication device, via a wired communication link performed via an earphone jack of the mobile communication device.

9. An add-on device according to claim 2, in which the indication is selectively generated according to a physical location of the mobile communication device.

10. An add-on device according to claim 2, further comprising a power source unit for powering said add-on device.

11. An add-on device according to claim 10, in which the power source unit includes a charger and a battery.

12. An add-on device according to claim 10, in which the power source unit includes a solar panel.

13. A communication apparatus according to claim 1, further comprising alerting means for indicating received messages, selected from the group consisting of an audible element, a tactile element, a visual element or any combination thereof.

14. A communication apparatus according to claim 1, in which the add-on device is integrated with a casing formed to accommodate the mobile communication device.

15. A messaging method for delivering messages from an add-on device to a mobile device, comprising the steps of:
receiving a one way broadcast from a transmission station, with no dependence on a cellular network, by a pager unit of said add-on device;
transferring said received message to the mobile device either wirelessly or by a wired communication link; and
processing said received message and selectively generating an indication regarding the received message by a software application executed by said mobile device according to one or more predefined rules selected from the group consisting of: physical location of the mobile device, sender, time, message priority or any combination thereof.

16. A method according to claim 15, wherein the indication is generated in form of: an audible indication, a tactile indication, a visual indication or any combination thereof.
